(19) United States
(12) Patent Application Publication
(10) Pub. No.: US 2015/0326466 A1
(43) Pub. Date: Nov. 12, 2015

(54) INFORMATION PROPAGATION IN A NETWORK

(71) Applicant: THOMSON LICENSING, Issy-les-Moulineaux (FR)

(72) Inventors: Nidhi HEGDE, Paris (FR); Laurent MASSOULIE, Vaucresson (FR); Jiang BO, Amherst, MA (US)

(73) Assignee: Thomson Licensing

(21) Appl. No.: 14/652,834

(22) PCT Filed: Nov. 29, 2013
(86) PCT No.: PCT/EP2013/075068

§ 371 Date: Jun. 17, 2015

(30) Foreign Application Priority Data
Dec. 18, 2012 (EP) 12306613.6

(51) Int. Cl. H04L 12/721

(52) U.S. Cl. CPC H04L 45/14

(57) ABSTRACT

Method for managing information propagation in a network, said information being propagated from a source to a receiving node device through a path of the network comprising at least one edge of the network directly linking a first and a second relaying node devices, wherein the method comprises a step of allocating to the second relaying node device a score each time that the receiving node device receives a useful content from the source through said path, wherein the first relaying node device is able to receive information from the second relaying node device at a given rate, and the method further comprises a stop of periodically updating said rate as a function of a sum of the scores allocated to the second relaying node device

### FIELD OF THE INVENTION

The present invention generally relates to networks.

More particularly, the invention deals with the propagation of information in a network where several devices publish information by pulling said information to neighboring devices in the network.

Thus, the invention concerns a method and a device for managing information propagation in a network. It also concerns a corresponding node device of a network and a computer program implementing the method of the invention.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Information dissemination has been transformed by the emergence of online social networks and their enthusiastic adoption by users. Users rely on trust relationships in social networks for accessing information. Thus, relationships form on the basis of the quality of information received, and in turn determine the speed of propagation in the network.

The study of the propagation of an information, called a rumor, in a social network goes back several years.

A typical model used in the prior art is the randomized broadcast model which is carried out in synchronized rounds. In each round, a user chooses a neighbor at random for propagating the rumor. The spreading mechanisms considered have been broadly of three types: push mechanisms where the user sends the rumor, if he has it, to the chosen neighbor; pull mechanisms where the user pulls the rumor from the chosen neighbor; and a combined mechanism, where the user pushes the rumor if he has it and pulls it if the chosen neighbor has it.

Some prior art considered an asynchronous model where each node contacts a neighbor after a random amount of time; nodes then pull content from the selected neighbor.

Furthermore, nowadays businesses use social networks for viral marketing. Viral marketing seeks to market a product, service, or idea by placing the marketing content in the hands of influential users that will distribute the content to other users. Unlike traditional marketing that may involve such activities as blasting advertisements on television or to various websites, viral marketing is often much cheaper and more effective at reaching target demographic audiences. Thus, companies are very interested in leveraging users' social networks to distribute information of interest to users in the networks. Besides, marketers want to know which users have been influential in getting information distributed, how information flows between users, and so forth so that future campaigns can be more effectively targeted.

In this context, the document US 2012/0158477 describes a social incentive system providing incentives and rewards to entities who participate in propagating the information, allowing heavy influencers to gain from their influence while a marketer rewards them.

However, previous works that have considered the problem of propagation of information in a social network in a distributed manner, do not consider the realistic scenario of a limited frequency of consultation as it is generally assumed that a user consults his neighbors continuously and among items of information he obtains, chooses to make available to his neighbors only a certain number of these items.

### SUMMARY OF THE INVENTION

The present invention proposes a solution for improving the situation.

Accordingly, the present invention provides a method for managing information propagation in a network comprising a plurality of node devices among which a receiving node device is able to receive information from a source node device, said information being propagated from the source node device to the receiving node device through a path of the network, said path comprising at least one edge of the network directly linking a first relaying node device and a second relaying node device, wherein the method comprises a step of allocating to the second relaying node device a score each time that the receiving node device receives a useful content from the source node device through said path, characterized in that the first relaying node device is able to receive information from the second relaying node device at a given rate, and in that the method further comprises a step of periodically updating said rate as a function of a sum of the scores allocated to the second relaying node device.

A useful content here means a piece of information that arrived earliest at the receiving node device, among all copies of this piece of information propagated in the network.

The given rate represents the rate at which a user associated with the first relaying node device, particularly in a social network, consults his neighbor associated with the second relaying node device in order to get contents, such as news updates, videos, advertisements, promotions, or other messages. By updating the neighbor consultation rates, the method of the present invention provides a mechanism that achieves information propagation within an optimal time in a distributed manner.

Besides, by this mechanism, a user would transmit a content to his neighbors, i.e. followers or friends, even if said content does not particularly interest himself.

Advantageously, the first relaying node device has a plurality of neighboring node devices directly linked to said first relaying node device through the network and the sum of the rates at which the first relaying node device is able to receive information from each neighboring node device is equal to a constant total rate.

This total rate represents the total budget of attention of the user associated with the first relaying node device. This budget of attention is naturally limited. Thus, the present invention, by automatically updating the rate at which the user consults each of his neighbors, enables an optimal allocation of the budget of attention of the user between his neighbors in the social network.

According to a first embodiment, the step of allocating is implemented by the receiving node device which allocates by itself the score to the second relaying node device of the path.

More particularly, in this case, the receiving node device allocates, i.e. rewards, directly a score to each relaying node device of the path. This embodiment is applicable when the receiving node device has knowledge of all the relaying node devices constituting the path.

According to a second embodiment, the step of allocating is implemented by the first relaying node device.

In this case, the receiving node device allocates a score to its neighboring relaying node device in the path. Then, each relaying node device rewards a score to its neighboring relaying node device in the path.

This second embodiment is particularly interesting when the receiving node device knows only its neighboring devices and has no knowledge of the network's topology.

The invention further provides a management device for managing information propagation in a network comprising a plurality of node devices among which a receiving node device is able to receive information from a source node device, said information being propagated from the source node device to the receiving node device through a path of the network, said path comprising at least one edge of the network directly linking a first relaying node device and a second relaying node device, wherein the management device comprises an allocation module for allocating to the second relaying node device a score each time that the receiving node device receives a useful content from the source node device through said path, characterized in that the first relaying node device is able to receive information from the second relaying node device at a given rate, and in that the management device further comprises an updating module for periodically updating said rate as a function of a sum of the scores allocated to the second relaying node device.

The invention also provides a node device of a network comprising the management device of the invention for managing information propagation.

The method according to the invention may be implemented in software on a programmable apparatus. It may be implemented solely in hardware or in software, or in a combination thereof.

Since the present invention can be implemented in software, the present invention can be embodied as computer readable code for provision to a programmable apparatus on any suitable carrier medium. A carrier medium may comprise a storage medium such as a floppy disk, a CD-ROM, a hard disk drive, a magnetic tape device or a solid state memory device and the like.

The invention thus provides a computer-readable program comprising computer-executable instructions to enable a computer to perform the method of the invention. The diagram of FIG. 3 illustrates an example of the general algorithm for such computer program.

### BRIEF DESCRIPTION OF THE DRAWINGS

The present invention is illustrated by way of examples, and not by way of limitation, in the figures of the accompanying drawings, in which like reference numerals refer to similar elements and in which:

FIG. 1 is a schematic view of a network according to an embodiment of the present invention;

FIG. 2 is a schematic view of a device according to an embodiment of the present invention;

FIG. 3 is a flowchart showing the steps of a method according to an embodiment of the present invention;

FIG. 4 shows an example of an incentive mechanism according to a first embodiment of the invention; and

FIG. 5 shows an example of an incentive mechanism according to a second embodiment of the invention.

### DETAILED DESCRIPTION OF PREFERRED EMBODIMENTS

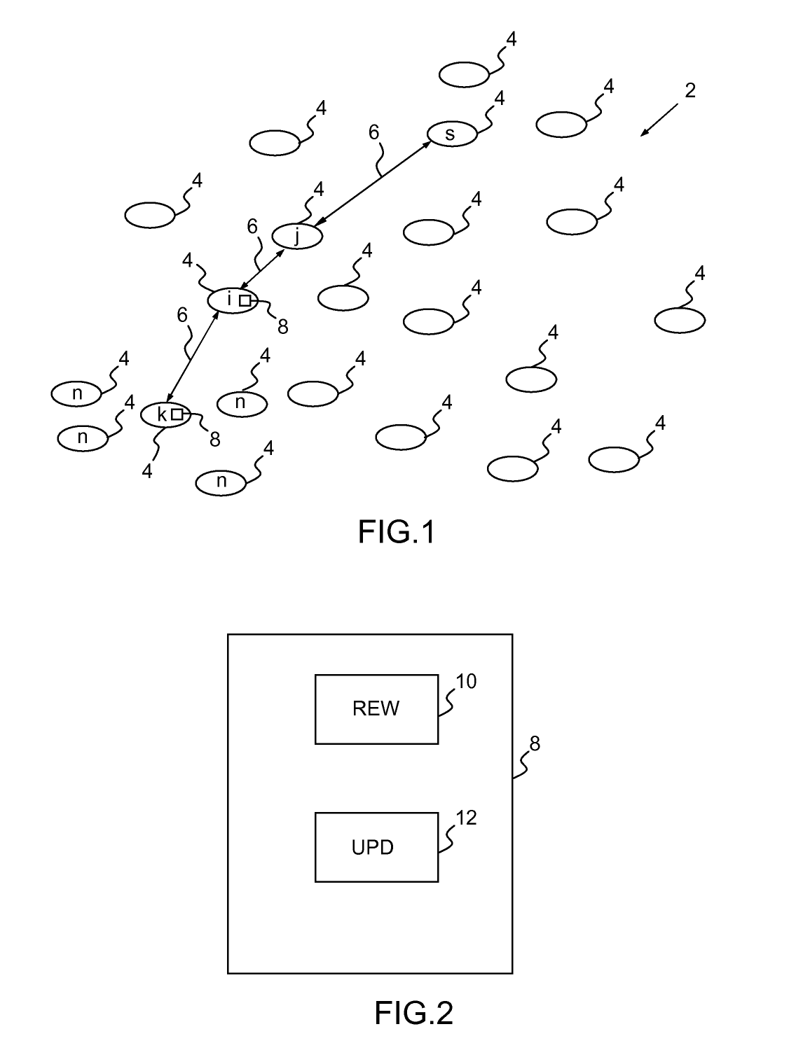

Referring to FIG. 1, there is shown therein a schematic view of a network 2 implementing the method of the invention. This network 2 is preferably a social network, for example Facebook, Twitter, Klout, Linkedin, Viadeo, Yahoo answers or any other social network 2 in which contents may be exchanged between users.

The network 2 comprises a plurality of node devices 4 associated to a plurality of m users.

Among the plurality of node devices 4, a node device k is able to receive information from another node device s, called a source, said information being propagated from the source s to the node device k through a path 6 of the network 2, said path comprising at least one edge (j,i) of the network directly linking a first relaying node device i and a second relaying node device j.

The existence of an edge between both relaying node devices i, j means that there's a link between the users associated to these node devices, i.e. these users are in contact with each other.

The path 6 represented as an example comprises the first relaying node device i, the second relaying node device j and the source node device s.

Each node device 4 consists in a user's terminal associated with a user connected to the network 2. Each user has a set of friends, or contacts, that he links to, or follows, in order to get content such as news updates, videos, or other messages. Each user then makes all content that he holds available to his followers, such as on the Facebook wall or on the Twitter stream. In a preferred embodiment of the invention, rather than a single source of content, all users can create content, at a given frequency, i.e. all node devices 4 of the network may constitute a source device s of information.

In FIG. 1, it is assumed that the user associated with the node device k has a plurality of contacts which are associated with the neighboring node devices n of the node device k. In this description, the term “a neighboring node” or “a neighbor” of the node device k means here that there is a direct link between said neighbor device and the node device k, i.e. information is propagated directly between them and not through a relaying node device.

Besides, it is assumed that the users seek to obtain all content circulating in the network 2. Thus, the users consult their contacts for the latest updates of information with the objective of minimizing the average delay for obtaining all information.

As a user may receive a same content more than one time, for example, from different contacts of said user, he considers only the earliest received content as a useful content. The copies of this useful content are not interesting for the user.

In the example, represented in FIG. 1, the user associated with the node device k receives for the first time the content propagated from the source s along the path 6. It is assumed that it receives this useful content through his neighbor i. Thus, said neighbor i is called a useful neighbor.

As in real online social networks, users have a limited budget of attention, i.e. the total frequency with which they may consult their contacts is limited. As such, this frequency must be allocated among the contacts in a manner that optimizes the delay for obtaining useful content.

The present invention provides, preferably each node device 4 of the network 2, with a management device 8 for managing information propagation in said network 2 under the limited budget of attention of users constraint.

The management device 8 is represented on FIG. 2.

The represented management device 8 is, for instance, the management device implemented either in the node device k or in the first relaying node device i. Due to the limited budget of attention of the user associated with the first relaying node device i, it is assumed that said first relaying node device i is able to receive information from the second relaying node device j at a rate yᵢⱼ.

The management device 8 comprises an allocation module 10 for allocating to the second relaying node device j a score each time that the node device k receives a useful content from the source s through the path 6. The management device 8 further comprises an updating module 12 for periodically updating the rate yᵢⱼ in order to optimize the delay for obtaining useful content by the node device k.

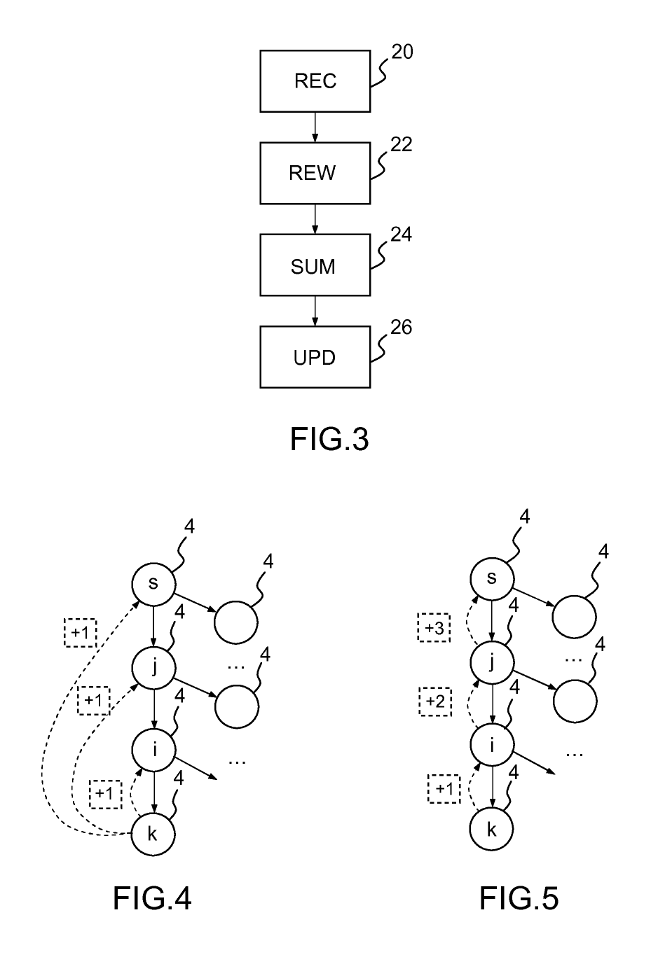

The operations implemented by the modules 10, 12 of the management device 8 will be detailed in the following with reference to the flowchart of FIG. 3.

As shown on FIG. 3, at a first step 20, the node device k receives the useful content from the source s for the first time through the first relaying node device i which is the useful neighbor.

At step 22, each node device along the path 6 linking the source s and the node device k, that was involved in relaying the useful content, is allocated, i.e. rewarded, a score.

According to a first embodiment, represented on FIG. 4, this rewarding is performed by the management device 8 implemented in the node device k which rewards by itself a score +1ₖ to each node of the path 6, and particularly to the node j. In the represented example, the score +1ₖ is equal to +1.

According to a second embodiment, represented on FIG. 5, the management device 8 implemented in the node device k rewards a score +1ₖ to its neighboring relaying node device in the path 6, i.e. the first relaying node device i. Then, the first relaying node device i rewards a score aggregating the score +1ₖ that it received from the node device k with its own score +1ᵢ to its neighboring relaying node device j in the path 6, i.e. to the second relaying node device j. Thus, the score +1ₖ rewarded to the second relaying node device j in this case is the sum of the score +1ₖ rewarded by the node device k to the first relaying node device i and of the score +1ᵢ rewarded to the second relaying node device j from the first relaying node device i. In the represented example, the scores +1ₖ, +1ᵢ, +1ⱼ rewarded by the node devices k, i, j, respectively, are equal to +1. Consequently, the first relaying node device i is rewarded a score equal to +1, the second relaying node device j is rewarded a score of +2 and the source device s is rewarded a score of +3.

The rewarded scores are considered as incentives because, as feedback, they represent the importance of a link, thus the value of the incentive to provide to bring about a favorable change in that link's allocation. These incentives may be monetary or non-monetary. Non-monetary incentives might include a form of reputation or recognition, such as in networks like Klout . In such networks, users receive votes that count towards their reputation or expertise, in return for some service, like answering questions, they provide to other users. A gain in reputation incites users to respond favorably when there is a possibility of receiving such votes. Remarkably, the method of the present invention incentivizes a user to “serve” other users, thus going beyond a selfish allocation of attention.

At step 24, the first relaying node device i keeps a score 0ⱼⁱ for the second relaying node device j equal to the sum of scores received by the node device j at step 22 each time said node device j relayed a useful content to the node device k.

By considering that the time scale at which a score is rewarded is equal to a slot, i.e. a score is sent per slot, at the end of a time period t which is chosen much longer than the slots over which the scores are sent, for example t=p*slot where p can be equal to at least 50 or 100, for example, the updating module 12 of the management device 8 implemented in the first relaying node device i updates the rate yᵢⱼ to be used for the next time period t+1 as follows:

$${y}_{ji} ( t + 1 ) = {y}_{ji} ( t ) - {γ}_{t} ( {δ}_{ji} ( t ) - \frac{{Σ}_{k} {δ}_{ki} ( t )}{{d}_{i}} ) , \\ where {δ}_{ji} ( t ) = - \frac{1}{m ( m - 1 ) {{y}_{ji} ( t )}^{2}} {O}_{j}^{i} , {γ}_{t} = 1 / t .$$

Thus, the present invention remarkably provides an incentive mechanism adjusting neighbor consultation rates so that the propagation of content is optimal.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention is not limited to the particular embodiments disclosed, but that the invention includes all embodiments falling within the scope of the appended claims.

Expressions such as “comprise”, “include”, “incorporate”, “contain”, is and “have” are to be construed in a non-exclusive manner when interpreting the description and its associated claims, namely construed to allow for other items or components which are not explicitly defined also to be present. Reference to the singular is also to be construed to be a reference to the plural and vice versa.

A person skilled in the art will readily appreciate that various parameters disclosed in the description may be modified and that various embodiments disclosed and/or claimed may be combined without departing from the scope of the invention.

1. Method for managing information propagation in a network comprising a plurality of node devices among which a receiving node device is able to receive information from a source node device, said information being propagated from the source node device to the receiving node device through a path of the network, said path comprising at least one edge of the network directly linking a first relaying node device and a second relaying node device, wherein the method comprises allocating to the second relaying node device a score each time that the receiving node device receives a useful content from the source node device through said path, wherein the first relaying node device is able to receive information from the second relaying node device at a given rate, and in that the method further comprises periodically updating said rate as a function of a sum of the scores allocated to the second relaying node device.

2. Method of claim 1, wherein the first relaying node device has a plurality of neighboring node devices directly linked to said first relaying node device through the network and the sum of the rates at which the first relaying node device is able to receive information from each neighboring node device is equal to a constant total rate.

3. Method of claim 1, wherein the step of allocating is implemented by the receiving node device which rewards by itself the score to the second relaying node device of the path.

4. Method of claim 1, wherein the step of allocating is implemented by the first relaying node device.

5. Management device for managing information propagation in a network comprising a plurality of node devices among which a receiving node device is able to receive information from a source node device, said information being propagated from the source node device to the receiving node device through a path of the network, said path comprising at least one edge of the network directly linking a first relaying node device and a second relaying node device, wherein the management device comprises an allocation module for allocating to the second relaying node device a score each time that the receiving node device receives a useful content from the source node device through said path, wherein the first relaying node device is able to receive information from the second relaying node device at a given rate, and in that the management device further comprises an updating module for periodically updating said rate as a function of a sum of the scores rewarded to the second relaying node device.

6. Node device of a network comprising the management device of claim 5.

7. A computer-readable program comprising computer-executable instructions to enable a computer to perform the method of claim 1.
